(19) United States
(12) Patent Application Publication
(10) Pub. No.: US 2010/0017711 A1
(43) Pub. Date: Jan. 21, 2010

(54) OPERATION GUIDANCE DISPLAY APPARATUS

(76) Inventors: Mitsuhiro Aso, Osaka (JP); Hideaki Yajima, Osaka (JP); Hidehiko Sin, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/439,458

(22) PCT Filed: Jun. 17, 2008
(86) PCT No.: PCT/JP2008/001562

§ 371 Date: Feb. 27, 2009

(30) Foreign Application Priority Data
Jun. 28, 2007 (JP) 2007-169931

(51) Int. Cl. G06F 3/01; G06F 13/38

(52) U.S. Cl. 715/708; 710/67

(57) ABSTRACT

Provided is an operation guidance display apparatus which enables improvement of an operability for a user. When an input device (101) is changed, a display information change rule extraction section (106) extracts a function display information change rule for displaying guidance display information having been extracted. A display information change section (107) invalidates, in the guidance display information having been extracted, a display rule for operation auxiliary information corresponding to input information which is not used as input information. The display information change section (107) generates an operable GUI representing the operation auxiliary information for symbol information having been invalidated, by using the input information defined in the input information conversion table, thereby performing an appropriate operation guidance display.

### TECHNICAL FIELD

The present invention relates to an operation guidance display apparatus for displaying an operation guidance as a part of a graphical user interface (GUI) in an electronic apparatus capable of allowing a user to perform an operation while confirming the GUI.

### BACKGROUND ART

In recent years, an electronic apparatus, such as a personal computer, a workstation, a mobile telephone, a digital television, and a digital video recording apparatus, displays a graphical user interface (GUI) by means of a display device (a CRT or a liquid crystal monitor) connected to each electronic apparatus so as to allow a user to intuitively use functions of the electronic apparatus easily.

The GUI is logically written as software executable on hardware (a CPU, a memory, and various input/output devices) configuring the electronic apparatus, and a graphic display on a screen of a display device is used for the GUI as means for providing a user with information. Further, the GUI is used to receive input information (sensor signal) from an input device, such as a keyboard, a mouse, or a remote controller, which is connected to an electronic apparatus, and to determine a content of a graphic display, and call a function of the electronic apparatus, based on a type of the input information.

The use of the GUI as described above enables an operation of a multifunctional electronic apparatus. For example, “guidance information display” is performed for displaying, on a screen of a display device, a method for operating an input device such as a mouse or a keyboard, and a function of a terminal which is executed through the operation of the input device, so as to associate the method with the function.

As an example of the guidance information display, an image (an image representing a key, a shape of a button, a position, or the like) and/or character information are displayed so as to enable identification of a component (for example, a specific key or button) of an input device which can be used by a user, and information indicating a function which can be used by operating a displayed input device are displayed on a part of a screen. The guidance information display allows a user to visually recognize a function which is executed when each button or key is pressed, and a button which can be used.

However, the guidance information is incorporated as software which can be used by a specific input device, and, when a configuration of an input device of an electronic apparatus is changed, an image representing an input device which is displaying the guidance information may not represent an actual configuration (shapes and arrangement of buttons and keys, and the like) of the input device, and therefore the guidance information cannot be used in some cases. For example, when a keyboard or a mouse is used as an input device of a personal computer, the keyboard or the mouse may be replaced with a keyboard or a mouse having another arrangement of buttons and/or another number of buttons in some cases.

In order to solve the problems described above, a conventional art (a character input device) is disclosed which changes and displays, in accordance with arrangement of keys, guidance information which assists in key input operation, so as to adapt an actual key arrangement to guidance display even when arrangement of function keys of a keyboard is different for each keyboard type, thereby preventing a user from performing an erroneous operation (for example, see Patent Document 1).

An operation performed by the conventional character input device disclosed in Patent Document 1 will be described with reference to FIG. 21 and FIG. 22. FIG. 21 is a diagram illustrating arrangements of function keys of keyboards used in the conventional character input devices. FIG. 22 is a diagram illustrating exemplary guidance information displayed by the conventional character input devices. The conventional character input device performs a guidance display 2201A shown in FIG. 22(a) so as to correspond to an arrangement of a function key 2102A of a keyboard 2101A shown in FIG. 21(a). A case in which, in this state, a keyboard used by the conventional character input device changes from the keyboard 2101A shown in FIG. 21(a) to a keyboard 2101B shown in FIG. 21(b) will be described. At this time, the conventional character input device changes the key arrangement to a key arrangement of a guidance display 2201B as shown in FIG. 22(b) so as to correspond to an arrangement of a function key 2102B of the keyboard 2101B shown in FIG. 21(b).
Patent Document 1: Japanese Laid-Open Patent Publication No. 8-272504

### DISCLOSURE OF THE INVENTION

### Problems to be Solved by the Invention

However, when the number of keys which have been set in designing a GUI is insufficient, or when a necessary key is not set, the conventional art is not able to appropriately change the guidance information. Therefore, there is a problem that a user may not use a function of an electronic apparatus, which is provided by a GUI designer.

Specifically, in a case where a GUI is designed such that eight function keys on a keyboard are assigned with eight functions, respectively, and guidance information indicates a function to be executed for each function key which is to be pressed, when a keyboard has eight or more function keys, the conventional art can change the guidance information display so as to correspond to key arrangement. However, when a keyboard having seven or less function keys is connected, a portion of functions assigned to the function keys, respectively, cannot be appropriately displayed as the guidance information, and therefore a user may not use the corresponding portion of the functions of the electronic apparatus in some cases.

Therefore, the present invention is made in order to solve the problems of the conventional art, and an object of the present invention is to provide an operation guidance display apparatus capable of replacing guidance information associated with unusable input information, with a GUI which can be operated by using other usable input information, and displaying the GUI, even when an input device having guidance information which is different from guidance information set in designing GUI is connected, thereby improving operability for a user.

### Solution to the Problems

The present invention is directed to an operation guidance display apparatus for outputting an operation guidance associated with an input device. In order to attain the object mentioned above, the operation guidance display apparatus according to the present invention comprises: an input device information management section for managing, in an input information conversion table, input information inputted through the input device and symbol information, so as to uniquely associate the input information with the symbol information; a function display information management section for managing, in a function display information change rule, the symbol information and a predetermined process which is to be executed when the symbol information is inputted, so as to associate the symbol information with the predetermined process; a function display section for converting the input information to the symbol information by using the input information conversion table managed by the input device information management section, and generating a GUI by executing the predetermined process in accordance with the function display information change rule corresponding to the symbol information obtained through conversion, and outputting the GUI having been generated; a guidance display information management section for managing, as guidance display information, information used for generating operation auxiliary information corresponding to a display state of the GUI generated by the function display section; an operation guidance display section for generating the operation auxiliary information in accordance with the guidance display information managed by the guidance display information management section, and outputting the operation auxiliary information having been generated; a display information change rule extraction section for performing comparison among the symbol information contained in the input information conversion table, the symbol information contained in the function display information change rule, and the symbol information contained in the guidance display information, and extracting the function display information change rule and the guidance display information which are associated with the symbol information that is not contained in the input information conversion table; and a display information change section for changing the guidance display information and the function display information change rule, both of which are extracted by the display information change rule extraction section, so as to be associated with the symbol information contained in the input information conversion table.

The display information change section changes the guidance display information extracted by the display information change rule extraction section so as to invalidate a display rule of the operation auxiliary information corresponding to the symbol information which is not contained in the input information conversion table, and to generate, as an operable GUI, the operation auxiliary information corresponding to the symbol information having been invalidated, by using the input information contained in the input information conversion table.

The operation guidance display apparatus may further comprise a display information storage section for storing the guidance display information and the function display information change rule. In this case, the display information change section may replace, when the guidance display information and the function display information change rule contain the symbol information which is not defined in the input information conversion table, the symbol information which is not defined in the input information conversion table, with the symbol information corresponding to unused input information, so as to change the guidance display information and the function display information change rule, and stores, in the display information storage section, the guidance display information and the function display information change rule having been changed.

Further, the present invention is also directed to a server device connected to a terminal device through a network, and the server device and the terminal device are included in an operation guidance display system for outputting an operation guidance associated with an input device. The server device according to the present invention comprises: a function display information management section for managing, in a function display information change rule, symbol information and a predetermined process which is to be executed when the symbol information is inputted, so as to uniquely associate the symbol information with the predetermined process; a guidance display information management section for managing, as guidance display information, information used for generating operation auxiliary information corresponding to a display state of a GUI; a display information change rule extraction section for performing, when receiving an input information conversion table in which input information inputted through the input device is uniquely associated with the symbol information, comparison among the symbol information contained in the input information conversion table, the symbol information contained in the function display information change rule, and the symbol information contained in the guidance display information, and extracting the function display information change rule and the guidance display information which are associated with the symbol information that is not contained in the input information conversion table; a display information change section for changing the guidance display information and the function display information change rule, both of which are extracted by the display information change rule extraction section, so as to be associated with the symbol information contained in the input information conversion table; and a transmission and reception section for receiving the input information conversion table from the terminal device through the network, and transmitting the function display information change rule and the guidance display information which have been changed by the display information change section, to the terminal device, through the network.

Further, the present invention is also directed to a terminal device connected to a server device through a network, and the terminal device and the server device are included in an operation guidance display system for outputting an operation guidance associated with an input device. The terminal device according to the present invention comprises: an input device information management section for managing, in an input information conversion table, input information inputted through the input device and symbol information, so as to uniquely associate the input information with the symbol information; a display information storage section for storing a function display information change rule for managing the symbol information so as to be associated with a predetermined process which is to be executed when the symbol information is inputted, and guidance display information managed as information used for generating operation auxiliary information which is displayed so as to correspond to a display state of a GUI; a transmission and reception section for transmitting, when the input information conversion table is updated, the input information conversion table having been updated, through the network to the server device, and receiving the guidance display information and the function display information change rule both of which are used for the input information conversion table having been updated, from the server device, through the network; a function display section for converting the input information to the symbol information by using the input information conversion table managed by the input device information management section, and generating a GUI by executing the predetermined process in accordance with the function display information change rule corresponding to the symbol information obtained through conversion, and outputting the GUI having been generated; and an operation guidance display section for generating the operation auxiliary information in accordance with the guidance display information, and outputting the operation auxiliary information having been generated.

Further, the present invention is also directed to a method performed by an operation guidance display apparatus for outputting an operation guidance associated with an input device. The operation guidance display apparatus according to the present invention includes: an input device information management section for managing, in an input information conversion table, input information inputted through the input device and symbol information, so as to uniquely associate the input information with the symbol information; a function display information management section for managing, in a function display information change rule, the symbol information and a predetermined process which is to be executed when the symbol information is inputted, so as to associate the symbol information with the predetermined process; and a guidance display information management section for managing, as guidance display information, information used for generating operation auxiliary information corresponding to a display state of a GUI. The method according to the present invention comprises the steps of: converting the input information to the symbol information by using the input information conversion table, and generating the GUI by executing the predetermined process in accordance with the function display information change rule corresponding to the symbol information obtained through conversion, and outputting the GUI having been generated; generating the operation auxiliary information in accordance with the guidance display information, and outputting the operation auxiliary information having been generated; performing comparison among the symbol information contained in the input information conversion table, the symbol information contained in the function display information change rule, and the symbol information contained in the guidance display information, and extracting the function display information change rule and the guidance display information which are associated with the symbol information that is not contained in the input information conversion table; and a display information change step of changing the guidance display information and the function display information change rule having been extracted, so as to be associated with the symbol information contained in the input information conversion table.

Further, the present invention is also directed to an integrated circuit of an operation guidance display apparatus for outputting an operation guidance associated with an input device. The operation guidance display apparatus according to the present invention includes: an input device information management section for managing, in an input information conversion table, input information inputted through the input device and symbol information, so as to uniquely associate the input information with the symbol information; a function display information management section for managing, in a function display information change rule, the symbol information and a predetermined process which is to be executed when the symbol information is inputted, so as to associate the symbol information with the predetermined process; and a guidance display information management section for managing, as guidance display information, information used for generating operation auxiliary information corresponding to a display state of a GUI. The integrated circuit comprises: a function display section for converting the input information to the symbol information by using the input information conversion table managed by the input device information management section, and generating the GUI by executing the predetermined process in accordance with the function display information change rule corresponding to the symbol information obtained through conversion, and outputting the GUI having been generated; an operation guidance display section for generating the operation auxiliary information in accordance with the guidance display information managed by the guidance display information management section, and outputting the operation auxiliary information having been generated; a display information change rule extraction section for performing comparison among the symbol information contained in the input information conversion table, the symbol information contained in the function display information change rule, and the symbol information contained in the guidance display information, and extracting the function display information change rule and the guidance display information which are associated with the symbol information that is not contained in the input information conversion table; and a display information change section for changing the guidance display information and the function display information change rule, both of which are extracted by the display information change rule extraction section, so as to be associated with the symbol information contained in the input information conversion table.

### Effect of the Invention

The operation guidance display apparatus according to the present invention displays guidance information associated with input information which cannot be used, as a GUI which can be operated, by using other usable input information, in the case where an input device in which the guidance information is not associated with a designed GUI is connected to an electronic apparatus, thereby improving an operability for a user.

### BRIEF DESCRIPTION OF THE DRAWINGS

FIG. 1 is a block diagram illustrating an exemplary configuration of an electronic apparatus including an operation guidance display apparatus according to a first embodiment of the present invention.

FIG. 2 is a diagram illustrating an exemplary input information conversion table according to the first embodiment of the present invention.

FIG. 3 is a diagram illustrating an example of a function display information change rule 301 according to the first embodiment of the present invention.

FIG. 4A is a diagram illustrating an example of a guidance display information change rule 401 according to the first embodiment of the present invention.

FIG. 4B is a diagram illustrating an example of a guidance display pattern 402 according to the first embodiment of the present invention.

FIG. 5 is a flow chart showing an exemplary operation performed by the operation guidance display apparatus according to the first embodiment of the present invention.

FIG. 6A is a diagram illustrating an exemplary case where the operation guidance display apparatus according to the first embodiment of the present invention is applied to a mobile telephone A.

FIG. 6B is a diagram illustrating an exemplary case where the operation guidance display apparatus according to the first embodiment of the present invention is applied to a mobile telephone B.

FIG. 7A is a diagram illustrating an exemplary case where the operation guidance display apparatus according to the first embodiment of the present invention is applied to a mobile telephone A.

FIG. 7B is a diagram illustrating an exemplary case where the operation guidance display apparatus according to the first embodiment of the present invention is applied to a mobile telephone B.

FIG. 8A is a diagram illustrating an example of a function display information change rule 801 (to be changed) according to the first embodiment of the present invention.

FIG. 8B is a diagram illustrating an example of a function display information change rule 802 (having been changed) according to the first embodiment of the present invention.

FIG. 9A is a diagram illustrating an exemplary case where the operation guidance display apparatus according to the first embodiment of the present invention is applied to a video recorder.

FIG. 9B is a diagram illustrating an exemplary case where the operation guidance display apparatus according to the first embodiment of the present invention is applied to a mobile telephone.

FIG. 10 is a block diagram illustrating an exemplary configuration of an operation guidance display apparatus according to a second embodiment of the present invention.

FIG. 11 is a flow chart showing an exemplary operation performed by the operation guidance display apparatus according to the second embodiment of the present invention.

FIG. 12 is a diagram illustrating an example of a guidance display pattern 1201 (having been changed) according to the second embodiment of the present invention.

FIG. 13A is a diagram illustrating an example of a function display information change rule 1301 (unchanged) according to the second embodiment of the present invention.

FIG. 13B is a diagram illustrating an example of a function display information change rule 1302 (having been changed) according to the second embodiment of the present invention.

FIG. 14 is a diagram illustrating an exemplary case where the operation guidance display apparatus according to the second embodiment of the present invention is applied to a mobile telephone.

FIG. 15 is a block diagram illustrating an exemplary configuration of an operation guidance display system according to a third embodiment of the present invention.

FIG. 16 is a flow chart showing an exemplary operation performed by a terminal device of the operation guidance display system according to the third embodiment of the present invention.

FIG. 17 is a flow chart showing an exemplary operation performed by a server device of the operation guidance display system according to the third embodiment of the present invention.

FIG. 18 is a flow chart showing an exemplary process performed by a display information change section 107 according to the third embodiment of the present invention.

FIG. 19A is a diagram illustrating an example of a guidance display pattern 402 (unchanged) according to the third embodiment of the present invention.

FIG. 19B is a diagram illustrating an example of a guidance display pattern 1901 (having been changed) according to the third embodiment of the present invention.

FIG. 20A is a diagram illustrating an example of a function display information change rule 801 (unchanged) according to the third embodiment of the present invention.

FIG. 20B is a diagram illustrating an example of a function display information change rule 2002 (having been changed) according to the third embodiment of the present invention.

FIG. 21 is a diagram illustrating an arrangement of keyboard function keys used in a conventional character input device.

FIG. 22 is a diagram illustrating an example of guidance information displayed by the convention character input device.

### DESCRIPTION OF THE REFERENCE CHARACTERS

101 input device

102 function display section

103 display device

104 input device information management section

105 function display information management section

106 display information change rule extraction section

107 display information change section

108 guidance display information management section

109 operation guidance display section

301 function display information change rule

401 guidance display information change rule

402 guidance display pattern

501 list-type GUI display

502 guidance information

503, 504 a portion of keyboard corresponding to input device of mobile telephone

701 GUI displayed by function display section

702 GUI displayed by operation guidance display section

703 GUI button displayed by function display section

704 GUI displayed by operation guidance display section

801 display information change rule (unchanged)

802 display information change rule (having been changed)

901 a portion of display device of remote controller

902, 904 GUI displayed by function display section

903, 906 GUI displayed by operation guidance display section

905 GUI button displayed by function display section

### BEST MODE FOR CARRYING OUT THE INVENTION

Hereinafter, embodiments of the present invention will be described with reference to the drawings.

### First Embodiment

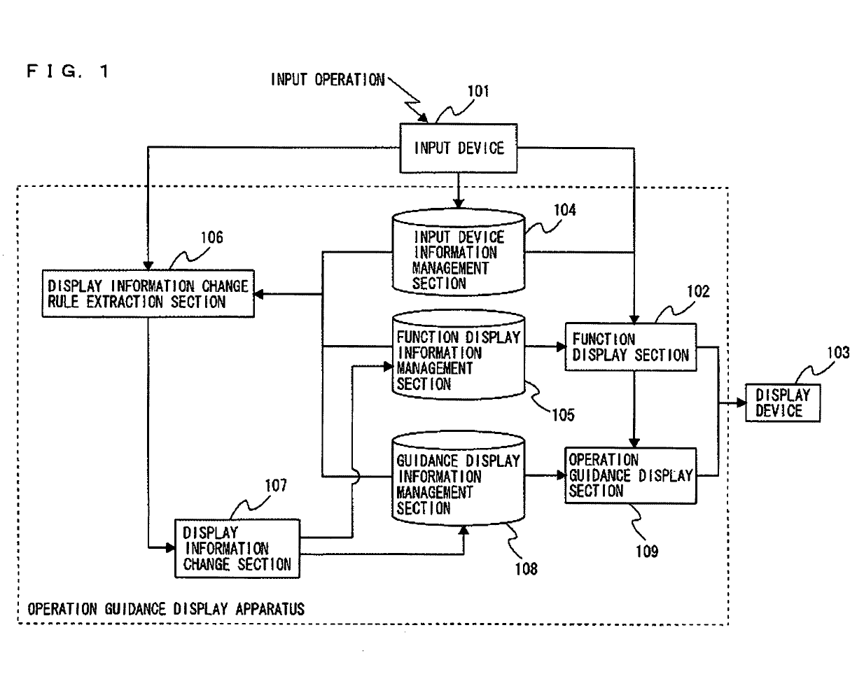

FIG. 1 is a block diagram illustrating an exemplary configuration of an electronic apparatus including an operation guidance display apparatus according to a first embodiment of the present invention. As shown in FIG. 1, the electronic apparatus includes an input device 101, an operation guidance display apparatus, and a display device 103. The operation guidance display apparatus includes a function display section 102, an input device information management section 104, a function display information management section 105, a display information change rule extraction section 106, a display information change section 107, a guidance display information management section 108, and an operation guidance display section 109.

The input device 101 is, for example, a keyboard of a personal computer, a keyboard of a mobile telephone, buttons of a remote controller of a television, a microphone, an acceleration sensor, or an angular velocity sensor. The input device 101 receives, from a user or an application, an input operation represented as, for example, an input signal generated when the button is pressed, an audio input signal from the microphone, or an input signal which represents a tilt, a rotation, and/or the like, of the electronic apparatus, detected by the acceleration sensor or the angular velocity sensor, and outputs, as input information, various sensor information obtained from the input operation.

The input device information management section 104 manages the input information from the input device 101 and symbol information which is determined in accordance with a predetermined rule, so as to uniquely associate the input information with the symbol informaiton. The association between the symbol information and the input information is stored as an input information conversion table. When a configuration of the input device 101 is changed, that is, for example, when another input device 101 is newly connected, or the connected input device 101 is disconnected, the input information conversion table has its content updated in accordance with the input device being changed. In the present embodiment, the input device information management section 104 manages the input information conversion table for each input device 101.

The input device information management section 104 may also manage the associations for a plurality of the input device 101 as one input information conversion table. For example, in a case where a remote controller is newly connected when a keyboard and/or a mouse are connected, information associated with the remote controller in addition to information associated with the keyboard and/or the mouse is managed in the input information conversion table. The input information conversion table will be described in detail below with reference to the drawings.

The display device 103 has a screen such as a liquid crystal display or a CRT display, and displays, on the screen, a graphical user interface (GUI) in accordance with instructions from the function display section 102 and/or the operation guidance display section 109.

The function display section 102 has means for generating a GUI to be displayed by means of the display device 103 based on a function display information change rule managed by the function display information management section 105. The GUI generated by the function display section 102 has its display content on the screen determined based on a predetermined process rule (the function display information change rule), in accordance with an input operation performed by a user on the input device 101, or the GUI can be used to execute a predetermined function. The function display information change rule will be described in detail below with reference to the drawings.

The function display section 102 needs to identify the input information received from the input device 101 so as to execute a process in accordance with an input operation performed by a user. The function display section 102 uses symbol information represented in the same format as the symbol information which is defined in the input information conversion table managed by the input device information management section 104 so as to identify the input information received from the input device 101.

Specifically, the function display section 102 receives, from the input device 101, input information generated by an operation performed by a user, and converts the input information to the symbol information by using the input information conversion table managed by the input device information management section 104. The function display information change rule for the symbol information obtained through the conversion is extracted from the function display information management section 105, and a process defined in the extracted rule is executed. Further, when a display state of the GUI displayed on the screen is changed by executing the process defined in the extracted rule, a display state change notification indicating a changed display state is issued to the operation guidance display section 109.

The function display information management section 105 associates the symbol information with a function calling process to be executed when the symbol information is inputted, and manages, as the function display information change rule, the symbol information and the function calling process so as to be associated with each other. When an operation is performed while a GUI is displayed, the function calling process to be executed can be uniquely determined based on the symbol information corresponding to the operation. The function display information change rule will be described in detail below with reference to the drawings.

The operation guidance display section 109 receives a display state change notification from the function display section 102, generates auxiliary information in accordance with the notified display state, and displays the auxiliary information by means of the display device 103. The auxiliary information generated by the operation guidance display section 109 is guidance information for guiding a user in operating, by using the input device 101, the GUI generated by the function display section 102. The auxiliary information is displayed as an image representing a configuration (for example, buttons and/or arrangement of keys) of the input device 101, and is also displayed as information representing characters and/or icons for allowing a user to identify an operation method. The operation guidance display section 109 refers to guidance display information managed by the guidance display information management section 108 so as to generate the guidance information. Further, the operation guidance display section 109 determines in detail display positions and display sizes of the respective buttons and character strings so as to display the respective elements of guidance display in a predetermined guidance display area in accordance with definitions of display patterns.

The guidance display information management section 108 manages the guidance display information. The guidance display information includes guidance display information change rule and guidance display pattern. The guidance display information change rule represents process rule used when the operation guidance display section 109 receives the display state change notification from the function display section 102. On the other hand, the guidance display pattern represents a collection of combinations of image data and/or character strings representing buttons and/or keys, with arrangement information thereof. The guidance information to be simultaneously displayed on a screen can be generated based on one display pattern.

When the display information change rule extraction section 106 detects that the input device 101 is changed, the display information change rule extraction section 106 performs a comparison among the symbol information which is defined in the input information conversion table managed by the input device information management section 104, the function display information change rule managed by the function display information management section 105, and the guidance display information managed by the guidance display information management section 108. The function display information change rule and the guidance display information which use the symbol information which is not defined in the input information conversion table managed by the input device information management section 104 are extracted and notified to the display information change section 107.

The display information change section 107 changes the extracted guidance display information so as to invalidate only the display rule for the operation auxiliary information which does not correspond to any input information of the input device 101, in the guidance display information extracted by the display information change rule extraction section 106, and the changed guidance display information is stored in the guidance display information management section 108. Further, the display information change section 107 stores, in the function display information management section 105, the function display information change rule for enabling generation of a GUI which can be executed by using some input information of the input device 101 and which represents the operation auxiliary information associated with the invalidated symbol.

The operation guidance display apparatus has the configuration as described above. Therefore, the operation guidance display apparatus determines whether or not the input information can be used based on the information representing the configuration of the input device 101, and can replace the guidance information associated with unusable input information, with a GUI which can be operated by using other usable input information, when the input device 101 providing guidance information different from guidance information which is set when a GUI is designed is connected to the electronic apparatus.

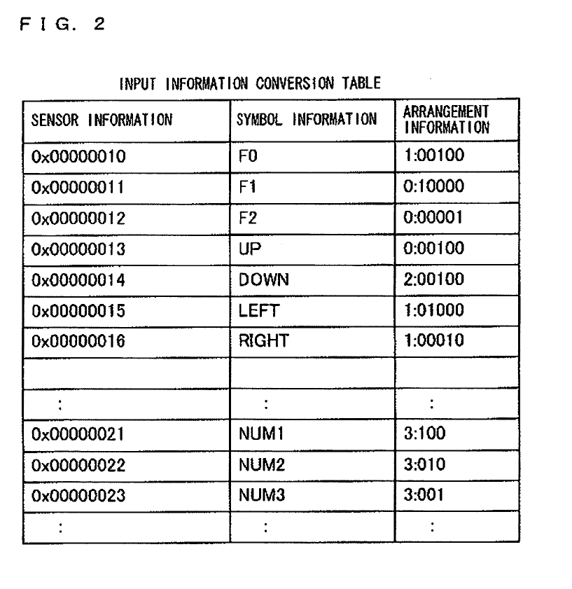

FIG. 2 shows an exemplary input information conversion table managed by the input device information management section 104. In an example shown in FIG. 2, the input information conversion table indicates sensor data strings, symbol information, and arrangement information. The sensor data string represents coded input signal of the input device 101. The symbol information is used for converting an input signal (a code indicated in the sensor data string) of the input device 101 to a predetermined symbol.

For example, when an input signal of the input device 101 is obtained as a 32 bit code of 0x00000016, the input signal is determined as having a symbol of “RIGHT”. When the “RIGHT” is predefined as a symbol representing “rightward”, defined is the input information conversion table for converting, into “RIGHT”, the input signal from a right key of a keyboard or a remote controller having a cross key representing, for example, upward, downward, leftward, and rightward. Alternatively, an input signal obtained when the input device 101 detects, by using various sensor information, that the input device 101 is moved rightward may be converted to “RIGHT”.

Further, the input information conversion table is used for managing information representing the configuration of the input device 101. For example, arrangement data string of the input information conversion table shown in FIG. 2 is used for managing information representing physical arrangement of the buttons of the input device 101 having button type input means such as a keyboard or a remote controller. In FIG. 2, the arrangement information “1:00010” corresponding to the symbol information “RIGHT” represents information “1:” indicating that a button corresponding to the “RIGHT” symbol of the input device 101 is positioned in the second row in the vertical direction when a user views the input device 101 from the front thereof, and information “00010” indicating that the button is positioned in the second row from the right in the horizontal direction when the user views the input device 101 from the front thereof. Similarly, it is indicated that a button corresponding to a symbol “F1” shown in FIG. 2 is positioned in the first row “0:” in the vertical direction and in the first row “10000” from the left in the horizontal direction. Information representing arrangement of the respective buttons can be obtained based on the arrangement information.

The input information conversion table is managed by the input device information management section 104 for each input device 101, and therefore, for example, when the configuration of the input device 101 is changed, the input information conversion table is updated in accordance with the content being changed. Specifically, when a remote controller in addition to a keyboard and/or a mouse is connected, the input information conversion table for the remote controller as well as the input information conversion tables for the keyboard and/or the mouse is managed by the input device information management section 104.

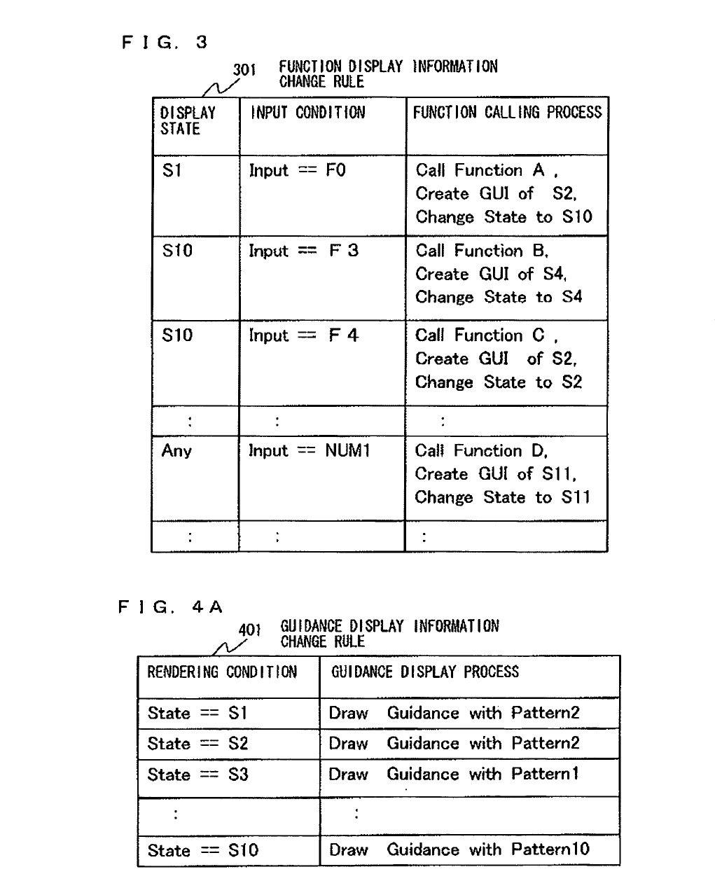

FIG. 3 is a diagram illustrating an example of the function display information change rule managed by the function display information management section 105. The function display section 102 displays a GUI representing the operation guidance by using the function display information change rule 301. When “display state” of the function display information change rule 301 indicates a state variable representing a display state of the GUI displayed on the screen of the display device 103. The subsequent “input condition” and “function calling process” indicate that a process indicated in the “function calling process” is performed, in accordance with the “display state” representing the display state of the GUI displayed on the screen, so as to correspond to the input information which is indicated in the “input condition” and is notified by the input device 101.

Specifically, in accordance with the function display information change rule, when the “display state” indicates S1, and the input information representing a symbol F0 is notified by the input device 101, the function “Function A” is performed, and GUI generation process “Create GUI of S2” for generating the GUI to be displayed on the screen of the display device 103 is performed, and the display state is changed to S2.

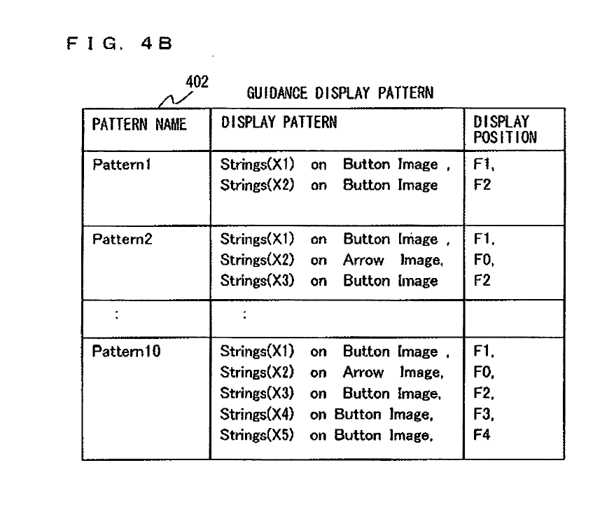

FIGS. 4A and 4B are diagrams illustrating an example of the guidance display information managed by the guidance display information management section 108. The guidance display information includes a guidance display information change rule 401 shown in FIG. 4A and a guidance display pattern 402 shown in FIG. 4B in this example.

The guidance display information change rule 401 represents a process rule used when the operation guidance display section 109 receives a display state change notification from the function display section 102. The guidance display information change rule 401 indicates that the operation guidance display section 109 performs, for each display state, an operation indicated in “guidance display process” so as to correspond to a “rendering condition” representing the display state (S1, S2, . . . ) notified by the function display section 102. Specifically, when the display state change notification representing the state change to S2 is received from the function display section 102, the guidance information of the display state represented as “Pattern2” is displayed.

The guidance display pattern represented as “Pattern2” is defined as one of patterns of the guidance display pattern 402 managed by the operation guidance display information management section 108, and is indicated in “pattern name” of the guidance display pattern 402. For example, the Pattern2 of the guidance display pattern 402 defines that a character string representing X1 is displayed on a button represented by image data, and a character string representing X2 is subsequently displayed on an arrow represented by image data, and a character string representing X3 is finally displayed on a button represented by image data. Further, in order to determine the display positions of the image data and the character data, “arrangement information” of the input information conversion table (FIG. 2) managed by the input device information management section 104 is obtained by using the symbol information indicated in the “display position” of the guidance display pattern 402, and relative positions of the buttons and keys, of the input device 101, represented by the respective symbols are obtained.

It is important to define a relationship among elements of the guidance display patterns when the guidance display patterns are defined. It is important to define the relationship among the elements, such as a relationship in which the character string representing X1 is displayed on a button image, or a relationship in which an arrow image is displayed subsequent to the button image, as a relative positional relationship among the symbols. The character strings representing X1, X2, X3 and the like are notified in addition to the display state when the function display section 102 notifies the guidance display information change rule of the display state change notification.

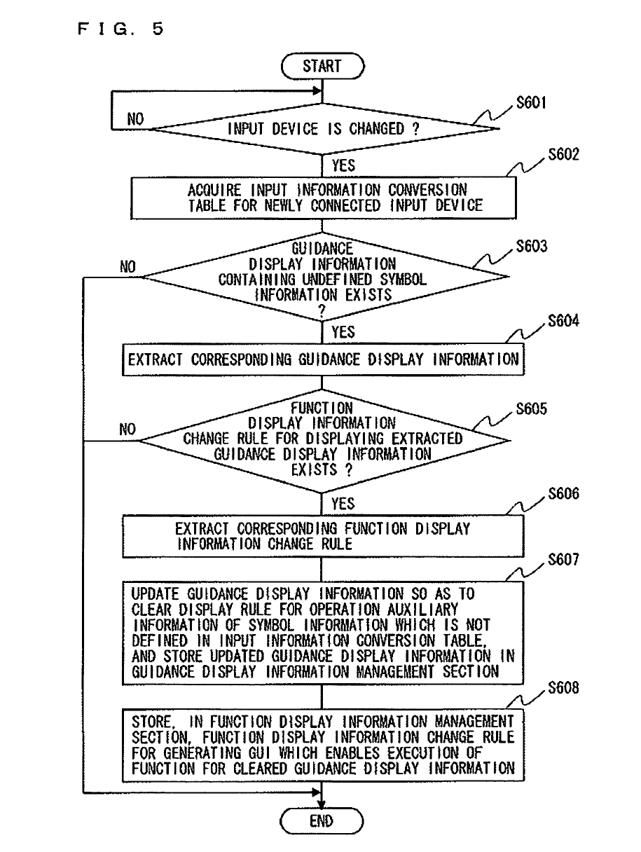

FIG. 5 is a flow chart showing an exemplary operation performed by the operation guidance display apparatus according to the first embodiment of the present invention. With reference to FIG. 5, an operation performed by the operation guidance display apparatus when the input device 101 is changed will be described. The electronic apparatus including the operation guidance display apparatus is powered on, and the starting-up is completed, and thereafter an operation of the operation guidance display apparatus is started.

With reference to FIG. 5, the display information change rule extraction section 106 determines whether or not input means of the input device 101 is changed (step S601), and when the display information change rule extraction section 106 determines that input means is changed (YES in step S601), the process advances to step S602. For example, the display information change rule extraction section 106 determines whether or not the input means of the input device 101 is changed, based on whether or not an initialization notification to be received when the input means of the input device 101 is changed is received.

The display information change rule extraction section 106 acquires, from the input device information management section 104, the input information conversion table (see FIG. 2) for the input device 101 having been newly connected (step S602), and compares the “symbol information” defined in the acquired input information conversion table with the guidance display information (FIGS. 4A and 4B) stored in the guidance display information management section 108, and determines whether or not the guidance display information including the symbol information which is not defined in the input information conversion table exists (step S603). When the guidance display information including the symbol information which is not defied in the input information conversion table exists (YES in step S603), the display information change rule extraction section 106 extracts the guidance display information (step S604).

The display information change rule extraction section 106 determines whether or not the function display information change rule stored in the function display information management section 105 includes the function display information change rule (FIG. 3) for displaying the extracted guidance display information (step S605). When the function display information change rule for displaying the extracted guidance display information is included, the display information change rule extraction section 106 extracts the function display information change rule (step S606).

When the guidance display information is not extracted (NO in step S603), or the function display information change rule is not extracted (NO in step S605), all the guidance display information are associated with the input information defined in the input information conversion table. Therefore, the display information change rule extraction section 106 determines that the updating of the function display information change rule is unnecessary, and the process is ended.

On the other hand, when the function display information change rule is extracted (YES in step S605), the display information change rule extraction section 106 notifies the display information change section 107 of the extracted guidance display information (FIGS. 4A and 4B) and the extracted function display information change rule (FIG. 3). The display information change section 107 changes the notified guidance display information so as to invalidate the display rule for the operation auxiliary information of the symbol information which is not defined in the input information conversion table (FIG. 2), thereby updating the guidance display information stored in the guidance display information management section 108 (step S607).

The display information change section 107 generates a GUI which is operable by using the input information defined in the input information conversion table and represents the operation auxiliary information for the invalidated symbol information, and updates the function display information change rule (FIG. 3) stored in the function display information management section 105 (step S608), and the process is ended.

In the aforementioned configuration, in a case where the input device 101 which has the guidance information which is different from the guidance information set when a GUI is designed is connected to an electronic apparatus, whether or not the input information can be used, based on information representing a configuration of the input device 101, and the guidance information associated with unusable input information can be displayed as a GUI which can be executed by using other usable input information.

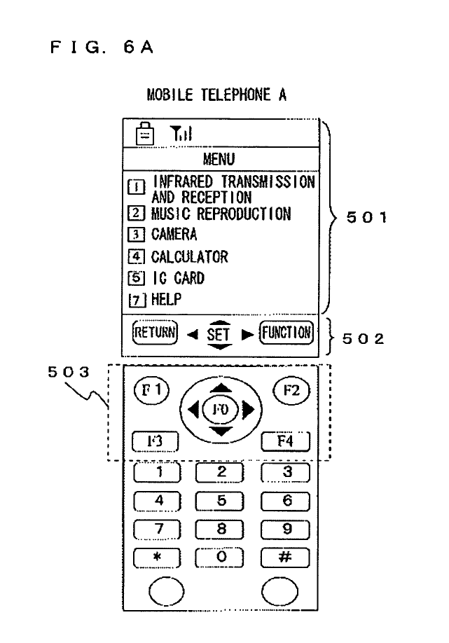

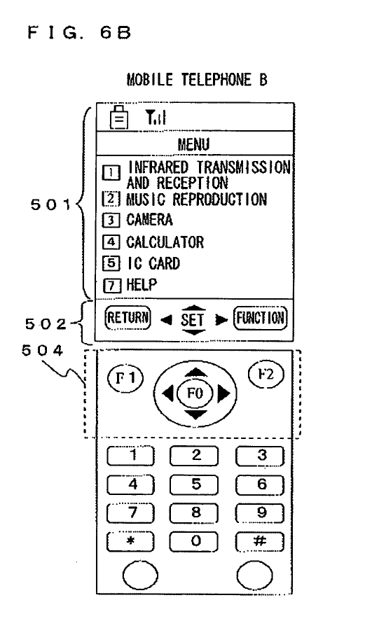

FIG. 6A and FIG. 6B each show an exemplary case where the operation guidance display apparatus according to the first embodiment of the present invention is applied to mobile telephones. Firstly, the description will be made under the condition that a mobile telephone A and a mobile telephone B each have, as a part of a GUI display program, the function of the operation guidance display apparatus according to the first embodiment of the present invention. Further, the mobile telephone B is designed such that the mobile telephone B can also use the GUI display program of the mobile telephone A.

In FIG. 6A and FIG. 6B, each of screens of display devices of the mobile telephone A and the mobile telephone B includes two areas, that is, an area 501 for displaying a content of a screen display associated with functions being executed in the mobile telephone, and an area 502 for displaying guidance information for guiding a user in operation. That is, a list-type GUI for allowing a selection of a function of the mobile telephone is displayed in the area 501. Guidance information is displayed as auxiliary information for indicating how to operate the list-type GUI display by using a portion, 503 or 504, of a keyboard corresponding to an input device of the mobile telephone.

In FIG. 6A and FIG. 6B, the list-type GUI in the area 501 is generated by the function display section 102 using a display information change rule managed by the function display information management section 105, and is displayed on the screen of the display device 103. On the other hand, the guidance information of the area 502 is generated by the operation guidance display section 109 using the guidance display information managed by the guidance display information management section 108, and is displayed on the screen of the display device 103.

When a configuration of the input device of the mobile telephone A is different from a configuration of the input device of the mobile telephone B, the operation guidance display apparatus according to the present embodiment displays the guidance information in the area 502 so as to correspond to each configuration. However, the display of the guidance information in the area 502 is the same between the mobile telephone A shown in FIG. 6A and the mobile telephone B shown in FIG. 6B.

In FIGS. 6A and 6B, each of the function display information change rule for displaying the list-type GUI in the area 501 and the guidance display information for displaying the guidance information in the area 502 does not include symbols which are different between the configurations of the input devices. Specifically, the guidance information of the area 502 is displayed by using characters representing “return”, “set”, and “function”, and image data representing F1, F2, F0, RIGHT, LEFT, UP, and DOWN buttons, which are common between the mobile telephone A and the mobile telephone B, among a button arrangement 503 which is a portion of a keyboard of the mobile telephone A, and a button arrangement 504 which is a portion of a keyboard of the mobile telephone B, so that the displayed guidance information is the same between the mobile telephone A and the mobile telephone B.

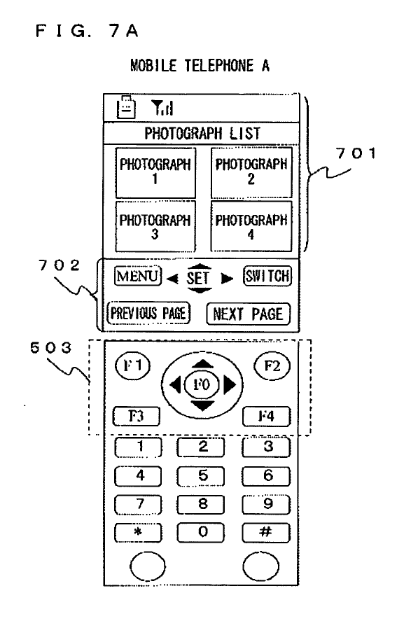

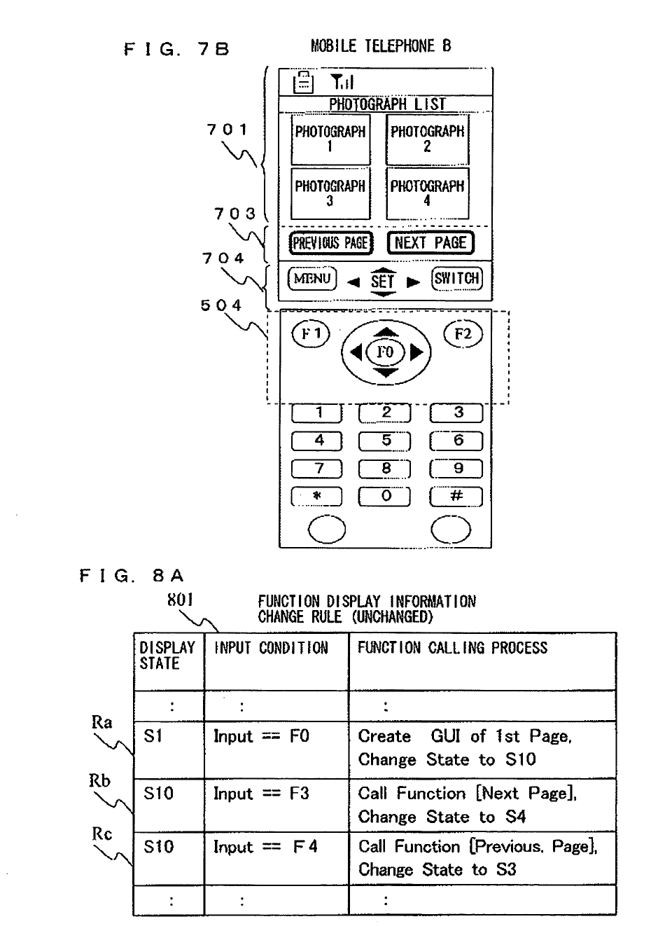

On the other hand, FIG. 7A and FIG. 7B show an exemplary case where the mobile telephone A shown in FIG. 6A and the mobile telephone B shown in FIG. 6B perform guidance displays, respectively, different from each other. The same components as shown in FIG. 6A and FIG. 6B are not described for FIG. 7A and FIG. 7B.

In FIG. 7A and FIG. 7B, a screen of a display device of the mobile telephone A includes two areas, that is, an area 701 for displaying a content of a screen display indicating functions being performed in the mobile telephone A, and an area 702 for displaying guidance information. On the other hand, a screen of a display device of the mobile telephone B includes three areas, that is, an area 701 for displaying a content of a screen display indicating functions being performed in the mobile telephone, an area 704 for displaying guidance information, and an area 703 for displaying additional guidance information.

In FIG. 7A and FIG. 7B, the GUI display of the area 701 is generated by the function display section 102 by using the function display information change rule (FIG. 3) managed by the function display information management section 105, and is displayed on the screen of the display device 103. Further, the guidance information of the areas 702 and 704 are generated by the operation guidance display section 109 based on the guidance display information (FIGS. 4A and 4B) managed by the guidance display information management section 108, and are displayed on the screen of the display device 103.

The guidance information displayed in the area 704 of the mobile telephone B by the operation guidance display section 109 is generated by using the guidance display information obtained by changing, by means of the display information change section 107, the guidance display information designed for the configuration of the input device of the mobile telephone A so as to correspond to the configuration of the input device of the mobile telephone B.

Further, the GUI display of the area 703 of the mobile telephone B is displayed by the function display section 102 as GUI buttons for enabling execution of functions of “previous page” and “next page” such that the mobile telephone B having no F3 and F4 buttons is able to execute the functions of “previous page” and “next page” executable in the mobile telephone A using the F3 and F4 buttons. The function display information change rule for displaying the GUI buttons is generated, by the display information change section 107, based on the difference between the configurations of the input devices of the mobile telephone B and the mobile telephone A, and is stored in the function display information management section 105. Specifically, the function of “previous page” or the function of “next page” can be selected by clicking a mouse, or can be executed by performing the same input operation as performed on the area 701 (by changing and setting a subject to be operated (for example, by switching from a photograph 1 to a photograph 2)).

An operation for generating the GUI display shown in FIG. 7B will be described in detail. The mobile telephone B has the function display information change rule and the guidance display information which are designed for the configuration of the input device of the mobile telephone A, and the function display information change rule and the guidance display information are changed so as to correspond to the configuration of the input device 101 of the mobile telephone B by the operation guidance display apparatus according to the present invention.

Initially, when the mobile telephone B is activated, the display information change rule extraction section 106 detects, in step S601, that the input device 101 of the mobile telephone B has been initialized (that is, that the input device is changed), and the process advances to step S602.

In step S602, the display information change rule extraction section 106 acquires the input information conversion table for the input device 101 of the mobile telephone B from the input device information management section 104. In this case, the input information conversion table for the input device 101 of the mobile telephone B is as shown in FIG. 2.

Next, in steps S603 and S604, the display information change rule extraction section 106 having acquired the input information conversion table shown in FIG. 2 compares the symbol information defined in the input information conversion table having been acquired, with the guidance display information stored in the guidance display information management section 108, and extracts the guidance display information including the symbol information which is not defined in the input information conversion table. Further, in steps S605 and S606, the display information change rule extraction section 106 extracts the function display information change rule for displaying the guidance display information having been extracted, and the process advances to step S607.

The guidance display information and the function display information change rule to be extracted will be described in detail. Initially, the guidance display information stored in the guidance display information management section 108 includes both the guidance display information change rule 401 shown in FIG. 4A, and the guidance display pattern 402 shown in FIG. 4B. The display information change rule extraction section 106 compares the “symbol information” of the input information conversion table (FIG. 2) with the symbol information indicated in the “display position” of the guidance display pattern 402 (FIG. 4B), and detects the guidance display pattern of “Pattern 10” as the guidance display information which includes F3 and F4 representing the symbol information which are not defined in the input information conversion table, and extracts the guidance display information change rule for “State==S10” using the guidance display pattern of “Pattern10”.

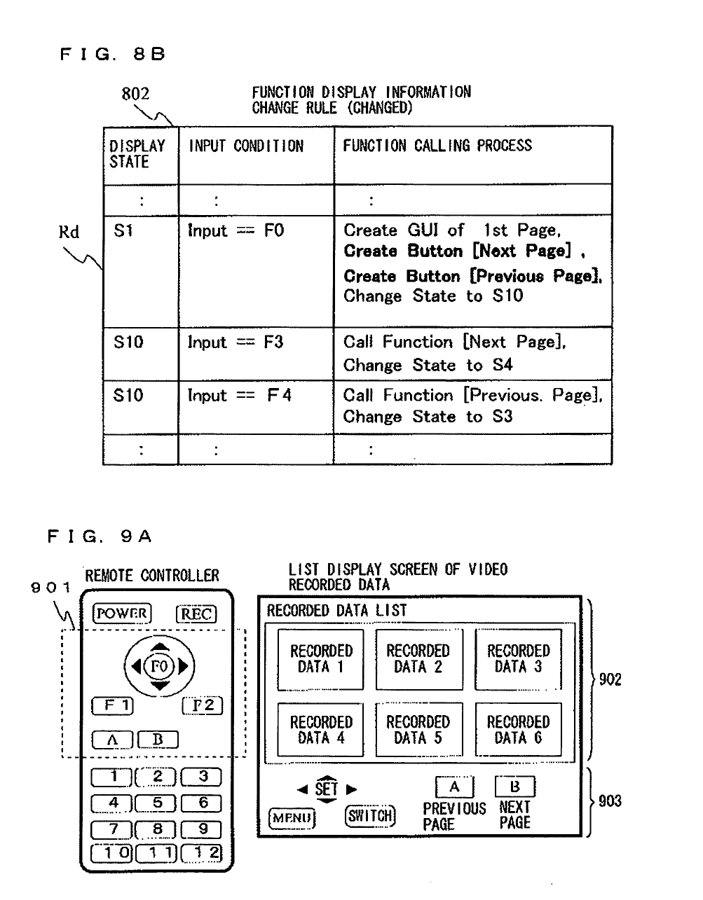

Next, when the function display information change rule managed by the function display information management section 105 is the function display information change rule 801, as shown in FIG. 8A, which is to be changed, Rb and Rc shown in FIG. 8A are extracted as the function display information change rule using the symbols of F3 and F4.

Finally, the function display information change rule (Ra shown in FIG. 8B) for changing the display state to S10 among the “display states” of S1, S2, . . . shown in FIGS. 4A, 4B, 8A, and 8B is extracted as the function display information change rule for displaying the guidance information by using the guidance display information change rule having been extracted.

In the process described above, the display information change rule extraction section 106 extracts the guidance display information change rule for “Pattern10” shown in FIGS. 4A and 4B, and the function display information change rule (Ra, Rb, Rc) shown in FIGS. 8A and 8B. The process advances to step S607.

In step S607, the display information change section 107 extracts “Pattern2” using F0, F1, and F2 as a pattern obtained by eliminating symbols of F3 and F4 from the guidance display pattern “Pattern10” having been extracted in step S604, and changes the “guidance display process” of the guidance display information change rule using “Pattern10” from “Draw Guidance with Pattern10” to “Draw Guidance with Pattern2”, and the guidance display information having been changed is stored in the guidance display information management section 108. Thereafter, the process advances to step S608.

When the guidance display pattern 402 does not include “Pattern2” using F0, F1, and F2, the display information change section 107 may update “Pattern10” as a new display pattern such that the guidance display pattern of “Pattern10” does not include the symbols of F3 and F4. Alternatively, “Pattern11” using F0, F1, and F2 may be added as a new display pattern.

Next, in step S608, the display information change section 107 changes the function display information change rule (Ra shown in FIG. 8A) extracted in step S606 to a function display information change rule for generating the GUI buttons for executing the functions of the mobile telephone such as “Next Page” and “Previous Page”, as indicated in Rd of the function display information change rule 802 (having been updated) shown in FIG. 8B. The function display information change rule having been changed is stored in the function display information management section 105, and the process is ended. At this time, the “Next Page” and “Previous Page” which are the functions executed by operating the GUI buttons are equivalent to “Call Function [Next Page]” and “Call Function [Previous Page]” executed in Rb and Rc with reference to the function display information change rule of Rb and Rc, respectively, having been extracted.

As described above, the operation guidance display apparatus according to the embodiment of the present invention enables automatic generation of the operation guidance display for the input device of the mobile telephone B, when the function display information change rule is written for the mobile telephone A, without re-designing the function display information change rule for the mobile telephone B which is to be developed, thereby reducing cost for designing and developing a GUI.

Further, even when a configuration of an input device of an electronic device is changed, the guidance information associated with unusable input information can be displayed, for each input device, as a GUI (for example, GUI buttons selectable by clicking a mouse) which can be directly operated by using usable input information.

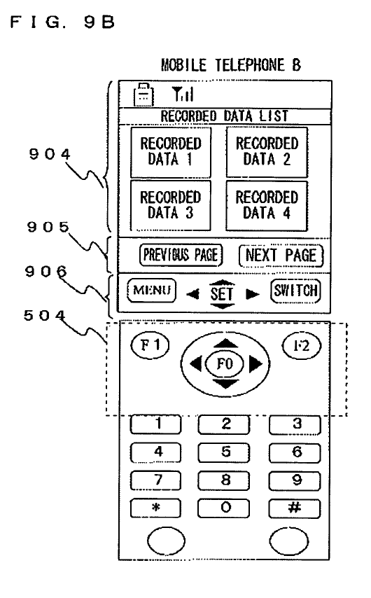

FIGS. 9A and 9B show an exemplary case where the operation guidance display apparatus according to the first embodiment of the present invention is applied to a video recorder and the mobile telephone B. FIGS. 9A and 9B show a video recorder and the mobile telephone B, respectively, both of which display “list display screen of video recorded data”. The video recorder and the mobile telephone B both include the recorded data list display program for operating the operation guidance display apparatus according to the present embodiment. The recorded data list display program is designed so as to be executed by using a remote controller.

In FIGS. 9A and 9B, GUIs 902 and 904 for displaying the recorded data list are each generated by the function display section 102 based on the function display information change rule managed by the function display information management section 105. Further, a guidance information display 903 is generated by the operation guidance display section 109 using the guidance display information managed by the guidance display information management section 108, and represents auxiliary information for indicating, to a user, an operation method in accordance with a configuration 901 of an input device of the video remote controller.

When the recorded data list display program is displayed by the mobile telephone B, the operation guidance display apparatus according to the present embodiment generates a button-type GUI (previous page, next page) as indicated in an area 905 so as to correspond to the configuration 504 of the input device of the mobile telephone B including no buttons A and B of the video remote controller, by performing the process described with reference to the flow chart of FIG. 5.

Therefore, a user of the mobile telephone B is able to use functions for moving to “previous page” and moving to “next page” on the mobile telephone B including no buttons A and B, by operating the generated button-type GUI of the area 905 through up, down, right, and left keys and a key for “set”.

The recorded data list display program shown in FIGS. 9A and 9B may be previously stored in the video recorder and the mobile telephone B. Alternatively, when the video recorder and the mobile telephone B are connected to a network, the mobile telephone B may download, from the video recorder or a server on the network, the recorded data list display program shown in FIGS. 9A and 9B as a program for displaying recorded data of the video recorder.

As described above, the operation guidance display apparatus according to the present invention changes the function display information change rule by means of the display information change section 107 such that the function display information change rule which is invalidated due to the configuration of the input device 101 being changed can be used by utilizing the input information of the input device 101 having been newly connected, so that the input device having been newly connected can perform an appropriate operation guidance display.

Further, also when, for example, various input devices (for example, a mouse, a key input of a mobile telephone, a remote controller of a television, and a special input device using a vibration sensor, a gyro sensor and/or the like) which are currently available, as well as a keyboard of a personal computer, are used, the guidance display can be changed so as to correspond to the input devices by the present invention although the shapes of the input devices, arrangements of buttons thereof, the number of the buttons, the usages of the buttons, and the like are various.

### Second Embodiment

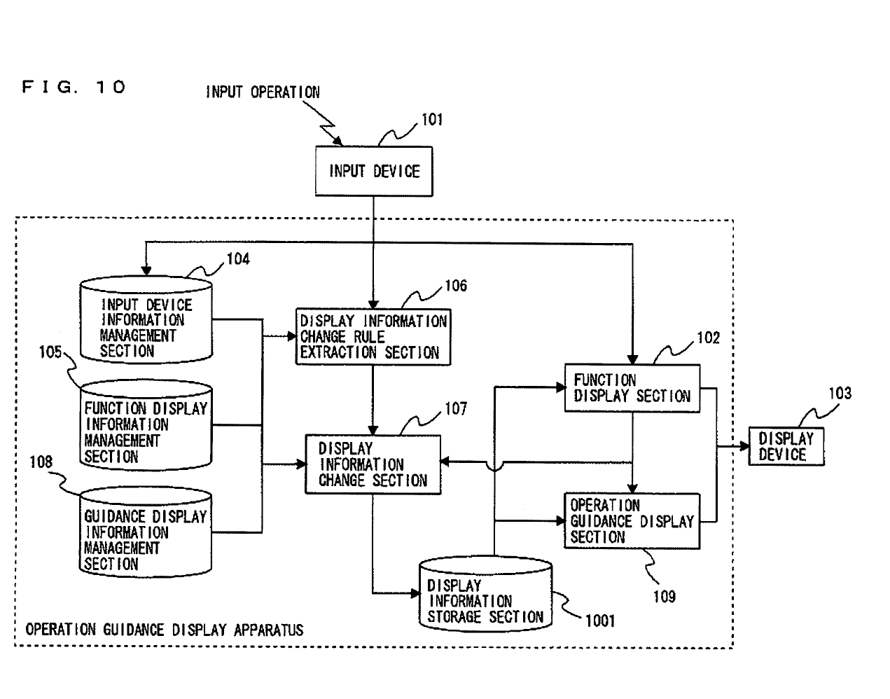

FIG. 10 is a block diagram illustrating an exemplary configuration of an operation guidance display apparatus according to a second embodiment of the present invention. The operation guidance display apparatus according to the second embodiment shown in FIG. 10 is different in configuration from the operation guidance display apparatus according to the first embodiment in that the operation guidance display apparatus according to the second embodiment includes a display information storage section 1001. The display information storage section 1001 stores the guidance display information and the function display information change rule.

The operation guidance display apparatus according to the second embodiment performs operations of steps S601 to S606 shown in FIG. 5 when the input device is changed, and performs operations subsequent thereto when a user performs an input operation.

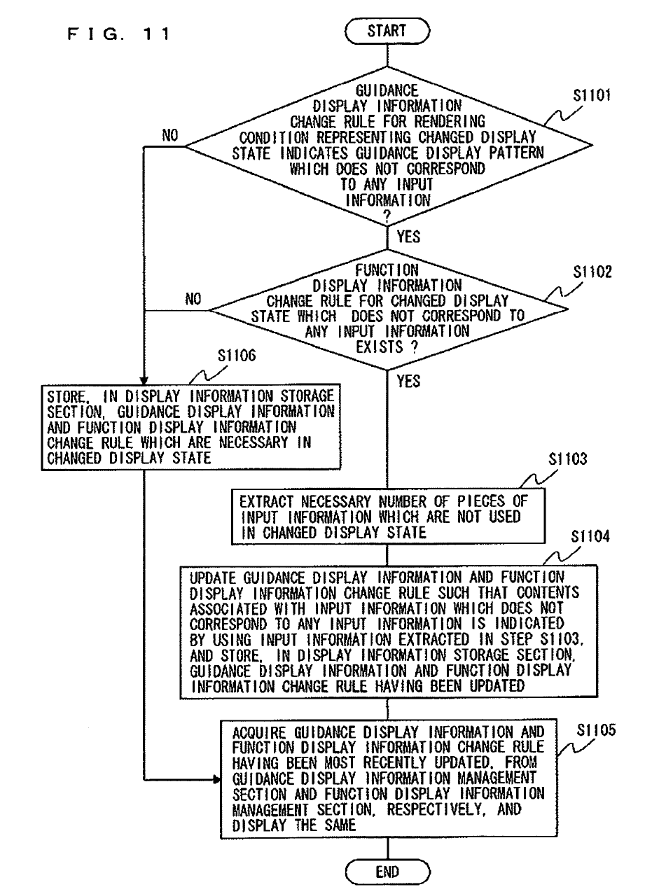

Hereinafter, an operation performed by the operation guidance display apparatus according to the second embodiment when a user performs an input operation will be described in detail. FIG. 11 is a flow chart showing an exemplary operation performed by the operation guidance display apparatus according to the second embodiment of the present invention.

As shown in FIG. 11, when a user performs an input operation, the display information change rule extraction section 106 determines whether or not the guidance display information change rule for the rendering condition representing the changed display state indicates a guidance display pattern which does not correspond to any of the input information (step S1101). The display information change rule extraction section 106 determines whether or not the guidance display information change rule indicates the guidance display pattern which does not correspond to any of the input information, based on whether or not the symbol information indicated in “display position” of the guidance display pattern 402 shown in FIG. 4B is defined in the input information conversion table shown in FIG. 2. In this exemplary case, “Pattern10” in which the symbol information of F3 and F4 indicated in “display position” are not defined in the input information conversion table corresponds to the guidance display pattern which does not correspond to any of the input information.

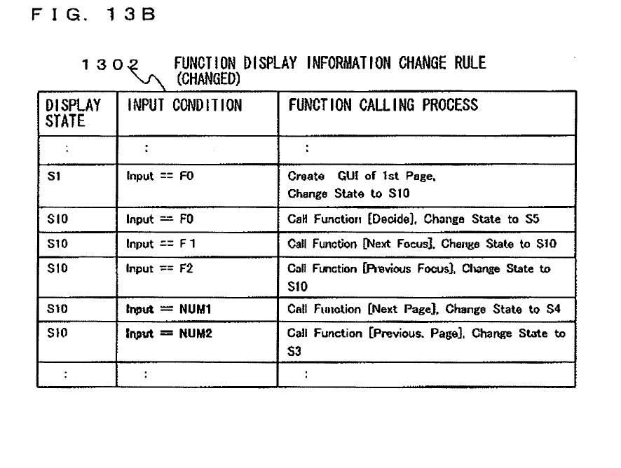

The display information change rule extraction section 106 determines whether or not the function display information change rule for the changed display state which does not correspond to any of the input information exists (step S1102). The function display information change rule for the changed display state which does not correspond to any of the input information is determined based on whether or not the changed display state S10 is defined therein. Specifically, a rule in which S10 is defined in “display state” in the function display information change rule 1301 which is shown in FIG. 13A (as an unchanged rule) corresponds to the function display information change rule which does not correspond to any of the input information.

The display information change rule extraction section 106 extracts the necessary number of pieces of the input information which are not used in the changed display state (step S1103). The input information which is not used in the changed display state is the symbol information which is defined in the input information conversion table shown in FIG. 2 but is not indicated in “input information” for the function display information change rule (FIG. 13B) indicating S10 as the changed display state in “display state”. The necessary number of pieces of the input information is the number of pieces of the symbol information which are not shown in FIG. 2 but indicated in the “display pattern” of the guidance display pattern “Pattern10” extracted in step S1101. That is, the necessary number of pieces of the input information is two, that is, F3 and F4. In this exemplary case, NUM1 and NUM2 are extracted in order, respectively.

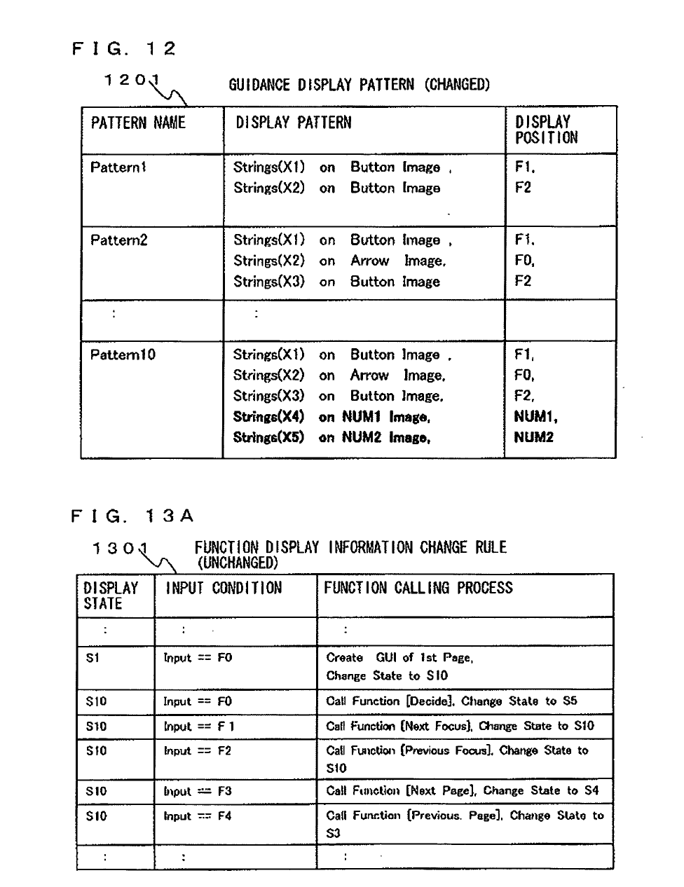

The display information change section 107 changes the guidance display information and the function display information change rule such that contents associated with the input information which does not correspond to any input information is indicated by using the input information extracted in step S1103, and the guidance display information and the function display information change rule are stored in the display information storage section 1101 (step S1104). That is, the display information change section 107 replaces contents defined as the symbol information of F3 and F4 in the guidance display information and the function display information change rule which are determined in steps S1101 and S1102, respectively, not to correspond to any input information, with the input information (NUM1, NUM2) extracted in step S1103. The guidance display pattern 1201 (see FIG. 12) having been changed and the function display information change rule 1302 (see FIG. 13B) having been changed are stored in the display information storage section 1101.

The function display section 102 and the operation guidance display section 109 acquire the function display information change rule (see FIG. 13B) having been most recently updated and the guidance display information (see FIG. 4A and FIG. 12) having been most recently updated, from the function display information management section 105 and the guidance display information management section 108, respectively, and displays are made (step S1105).

When the determination in step S1101 and S1102 are each “NO”, the display information change section 107 stores, in the display information storage section 1001, the guidance display information and the function display information change rule which are necessary in the changed display state (step S1106).

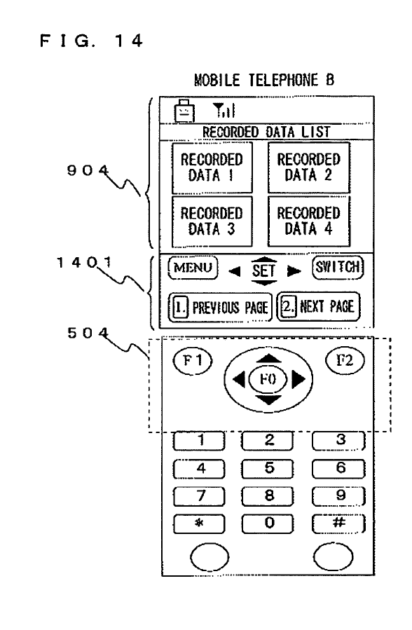

FIG. 14 is a diagram illustrating the mobile telephone B displaying “list display screen of video recorded data” which is operated by using the remote controller shown in FIG. 9A. The screen of the mobile telephone B shown in FIG. 14 is a screen of a mobile telephone in the display state S10 obtained immediately after a user presses F0 key in the display state S1 indicated in the function display information change rule 801 (unchanged) shown in FIG. 8A. The screen shown in FIG. 14 is different from the screen shown in FIG. 9A in that the screen shown in FIG. 14 represents, in “GUI portion displayed by the operation guidance display section” in an area 1401, a guidance display in which the NUM1 and NUM2 keys which are not used in the display state S10 are assigned to keys for calling functions of “previous page” and “next page”, due to the mobile telephone B having no F3 and F4 keys. The area 1401 is generated by the operation guidance display section 109 based on the “Pattern10” of the (changed) guidance display pattern 1201, shown in FIG. 12, which is stored in the display information storage section 1001, and displayed by the display device 103.

### Third Embodiment

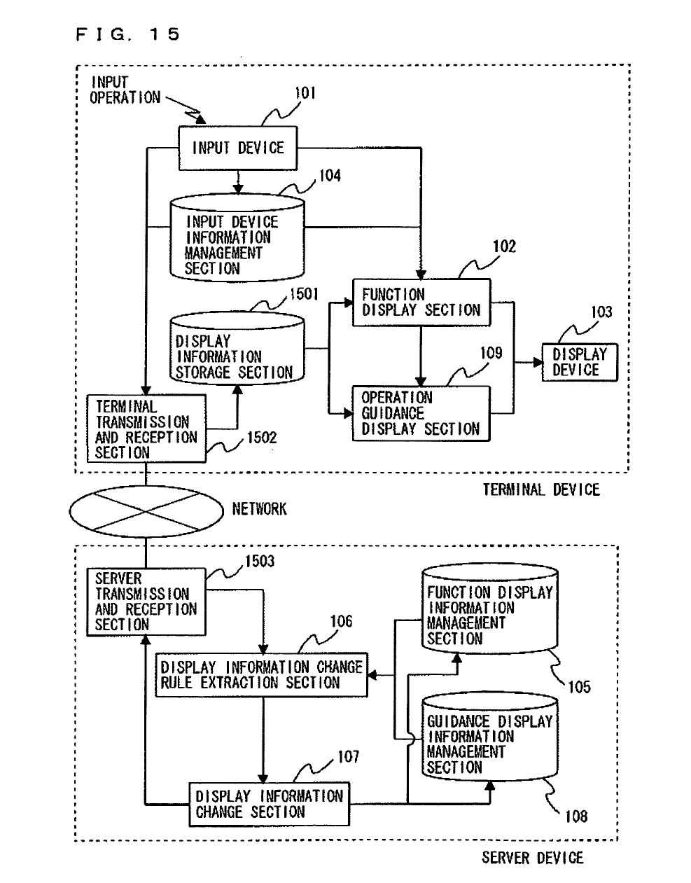

FIG. 15 is a block diagram illustrating an exemplary configuration of an operation guidance display system according to a third embodiment of the present invention. As shown in FIG. 15, the operation guidance display system according to the third embodiment is configured such that the function of the operation guidance display apparatus according to the first embodiment is executed by a terminal device and a server device connected to each other through a network.

The terminal device includes the input device 101, the function display section 102, the display device 103, the input device information management section 104, the operation guidance display section 109, a display information storage section 1501, and a terminal transmission and reception section 1502. The terminal device may not necessarily include the input device 101 and the display device 103 as components thereof. In this case, the terminal device may use the input device 101 and the display device 103 which are provided outside the terminal device and connected thereto. The display information storage section 1501 stores the function display information change rule and the guidance display information. The terminal transmission and reception section 1502 has a function of transmitting and receiving various information through the network. The function display section 102 and the operation guidance display section 109 display GUIs to be used by a user operating the terminal, based on the function display information change rule and the guidance display information stored in the display information storage section 1501.

The server device includes the function display information management section 105, the display information change rule extraction section 106, the display information change section 107, the guidance display information management section 108, and a server transmission and reception section 1503. The server transmission and reception section 1503 has a function of transmitting and receiving various information through the network. In the first embodiment, the display information (the function display information change rule and the guidance display information) are changed by the display information change section 107 and are stored in the function display information management section 105 and the guidance display information management section 108, respectively. On the other hand, in the operation guidance display system according to the third embodiment, the server transmission and reception section 1503 transmits, to the terminal transmission and reception section 1502, the display information (the function display information change rule and the guidance display information) having been changed, and the display information received by the terminal transmission and reception section 1502 is stored in the display information storage section 1501.

Next, operations performed by the terminal device and the server device of the operation guidance display system according to the third embodiment of the present invention will be separately described. FIG. 16 is a flow chart showing an exemplary operation performed by the terminal device of the operation guidance display system according to the third embodiment of the present invention. As shown in FIG. 16, when the input device 101 is changed (step S1601), the input device information management section 104 acquires, from the input device 101 having been newly connected, the input information conversion table (FIG. 2) for the input device 101 having been newly connected, and registers the input information conversion table. Subsequently, the registered input information conversion table is transmitted to the server device through the terminal transmission and reception section 1502 (step S1602). Next, the terminal transmission and reception section 1502 receives, from the server device, the display information (the guidance display information and the function display information change rule) for the newly connected input device, and the display information is stored in the display information storage section 1501 (step S1603).

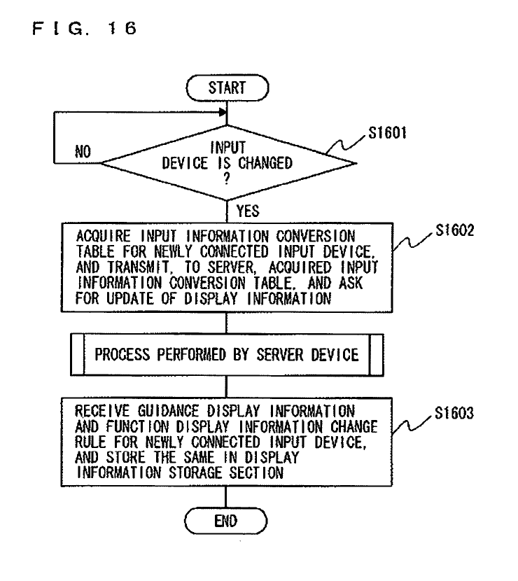

FIG. 17 is a flow chart showing an exemplary operation performed by the server device of the operation guidance display system according to the third embodiment of the present invention. As shown in FIG. 17, when the server transmission and reception section 1503 receives, from the terminal transmission and reception section 1502, the input information conversion table (FIG. 2) of the input device 101 having been newly connected, the process step of step S1701 is started.

As shown in FIG. 17, when the input information conversion table (FIG. 2) is received, the display information change rule extraction section 106 compares the symbol information defined in the input information conversion table having been acquired, with the guidance display information stored in the guidance display information management section 108, and determines whether or not the guidance display information including the symbol information which is not defined in the input information conversion table exists (step 1701). When the guidance display information including the symbol information which is not defined in the input information conversion table exists (YES in step S1701), the display information change rule extraction section 106 extracts the guidance display information (step S1702).

The display information change rule extraction section 106 determines whether or not the function display information change rule stored in the function display information management section 105 includes the function display information change rule for displaying the extracted guidance display information (step S1703). When the function display information change rule for displaying the extracted guidance display information is included, the display information change rule extraction section 106 extracts the function display information change rule (step S1704).

When no guidance display information is extracted (NO in step S1701), or when no function display information change rule is extracted (NO in step S1703), all the guidance display information are associated with the input information defined in the input information conversion table, and therefore the display information change rule extraction section 106 determines that the function display information change rule need not be updated, and the process is ended.

When the function display information change rule is extracted (YES in step S1703), the display information change rule extraction section 106 notifies the display information change section 107 of the guidance display information and the function display information change rule which have been extracted. The display information change section 107 changes the notified guidance display information such that a display rule for operation auxiliary information of the symbol information which is not defined in the input information conversion table is invalidated, thereby updating the guidance display information stored in the guidance display information management section 108 (step S1705).

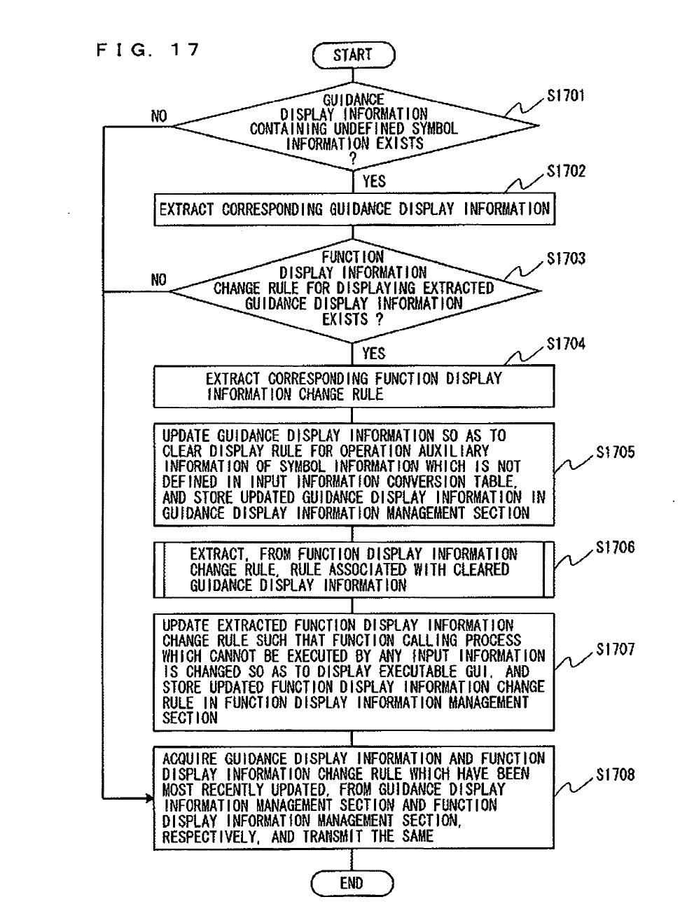

The display information change rule extraction section 106 extracts a rule associated with the guidance display information having been invalidated, from the function display information change rule (step S1706). Step S1706 will be described in detail with reference to FIG. 18.

The display information change section 107 changes the function display information change rule having been extracted such that a function calling process which cannot be executed by any input information is changed so as to display an executable GUI, and the changed function display information change rule is stored in the function display information management section 105 (step S1707).

The display information change section 107 acquires the guidance display information and the function display information change rule which have been most recently updated, from the guidance display information management section 108 and the function display information management section 105, respectively, and the server transmission and reception section 1503 transmits the most recent display information to the terminal device, and the process performed by the server is ended (step S1708). Subsequent process is step S1603 performed by the terminal.

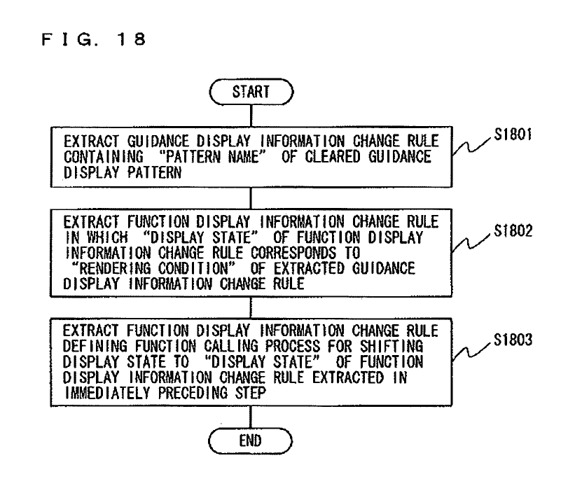

FIG. 18 is a flowchart illustrating an exemplary process performed by the display information change section 107 according to the third embodiment of the present invention. As shown in FIG. 18, the display information change section 107 extracts the guidance display information change rule including the “pattern name” of the guidance display pattern having been invalidated (step S1801). The guidance display pattern having been invalidated is the changed guidance display pattern including Pattern10 shown in FIG. 19B. Further, the guidance display information change rule including “Pattern10” is a rule satisfying “State==S10” as the rendering condition of the guidance display information change rule 401 shown in FIG. 4A.

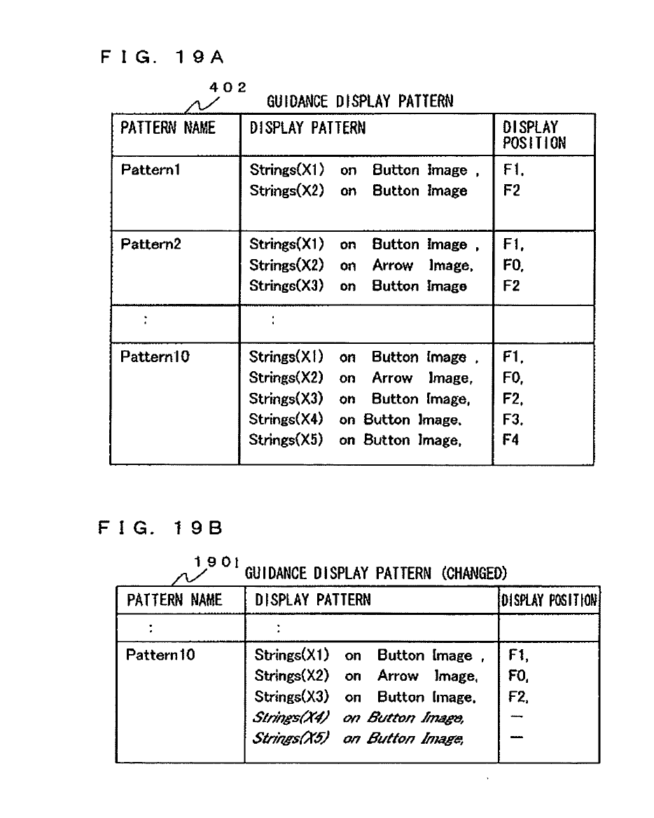

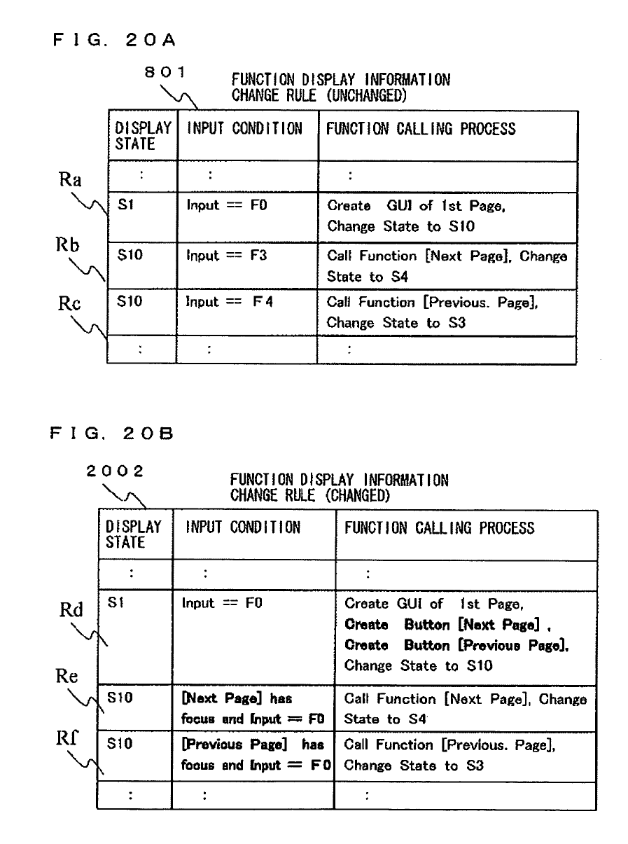

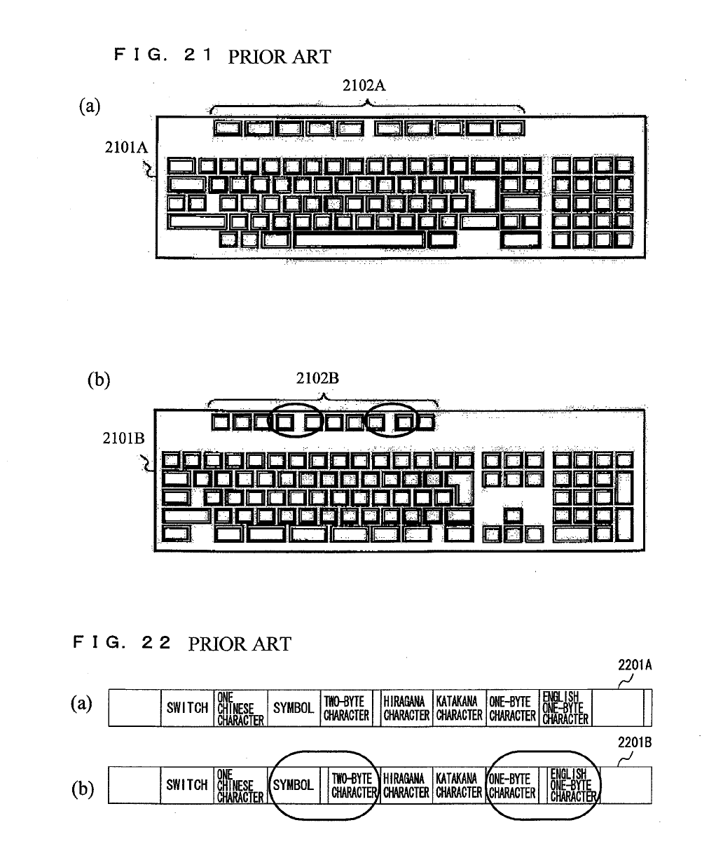

Next, the display information change section 107 extracts the function display information change rule including “display state” which indicates the same content as “rendering condition” of the guidance display information change rule having been extracted (step S1802). In this case, Rb and Rc of the unchanged function display information change rule 801 shown in FIG. 20A are extracted as the function display information change rule including “display state” which corresponds to the rendering condition of S10.

Next, the display information change section 107 extracts the function display information change rule defining the function calling process for shifting the display state to “display state” of the function display information change rule having been extracted in the immediately preceding process step (step S1803). In this case, the function display information change rule Ra indicating “Change State to S10” in the function calling process is extracted from the unchanged function display information change rule 801 shown in FIG. 20A.

As described above, the function of the operation guidance display apparatus is realized by the terminal device and the server device connected to each other through the network, thereby reducing processing load and memory capacity required for the terminal device.

A highly portable GUI program which is developed by using JAVA (registered trademark) language and the like, and is operable on various electronic devices has been used. Even in such a GUI program, the guidance information is developed so as to correspond to an input device of a specific electronic apparatus (for example, the JAVA (registered trademark) program for a mobile telephone displays a guidance for a keyboard of the mobile telephone). Therefore, the guidance information display cannot be changed so as to correspond to a configuration of an input device of every electronic apparatus. However, the present invention realizes the GUI program which is capable of displaying a guidance so as to correspond to a configuration of an input device of each electronic apparatus.

Further, in each embodiment of the present invention, the functional blocks of the operation guidance display apparatus are typically realized as programs, respectively, operating on the CPU. However, a part or all of the functions may be realized as LSIs which are each an integrated circuit. Each of the LSIs may be constructed as a chip form, or the LSIs may be provided as one chip including a part or all of the LSIs. The LSI may be referred to as an IC, a system LSI, a super LSI, or an ultra LSI depending on a degree of integration.

Further, the method of integration is not limited to LSI, and may be realized by a dedicated circuit or a general purpose processor. An FPGA (FIELD PROGRAMMABLE GATE ARRAY), which is an LSI that can be programmed after manufacture, or a reconfigurable processor enabling connections and settings of the circuit cells in the LSI to be reconfigured may be used.

Moreover, in the case where another integration technology replacing LSI becomes available due to improvement of a semiconductor technology or due to the emergence of another technology derived therefrom, integration of the functional blocks may be performed using the technology. For example, biotechnology may be applied.

### INDUSTRIAL APPLICABILITY

The operation guidance display apparatus according to the present invention is applicable to, for example, an apparatus, such as a mobile telephone, an AV apparatus, a household electrical appliance, which enables an input operation using an input device.

1. An operation guidance display apparatus for outputting an operation guidance associated with an input device, the operation guidance display apparatus comprising:
an input device information management section for managing, in an input information conversion table, input information inputted through the input device and symbol information, so as to uniquely associate the input information with the symbol information;
a function display information management section for managing, in a function display information change rule, the symbol information and a predetermined process which is to be executed when the symbol information is inputted, so as to associate the symbol information with the predetermined process;
a function display section for converting the input information to the symbol information by using the input information conversion table managed by the input device information management section, and generating a GUI by executing the predetermined process in accordance with the function display information change rule corresponding to the symbol information obtained through conversion, and outputting the GUI having been generated;
a guidance display information management section for managing, as guidance display information, information used for generating operation auxiliary information corresponding to a display state of the GUI generated by the function display section;
an operation guidance display section for generating the operation auxiliary information in accordance with the guidance display information managed by the guidance display information management section, and outputting the operation auxiliary information having been generated;
a display information change rule extraction section for performing comparison among the symbol information contained in the input information conversion table, the symbol information contained in the function display information change rule, and the symbol information contained in the guidance display information, and extracting the function display information change rule and the guidance display information which are associated with the symbol information that is not contained in the input information conversion table; and
a display information change section for changing the guidance display information and the function display information change rule, both of which are extracted by the display information change rule extraction section, so as to be associated with the symbol information contained in the input information conversion table.

2. The operation guidance display apparatus according to claim 1, wherein the display information change section changes the guidance display information extracted by the display information change rule extraction section so as to invalidate a display rule of the operation auxiliary information corresponding to the symbol information which is not contained in the input information conversion table, and to generate, as an operable GUI, the operation auxiliary information corresponding to the symbol information having been invalidated, by using the input information contained in the input information conversion table.

3. The operation guidance display apparatus according to claim 1, further comprising a display information storage section for storing the guidance display information and the function display information change rule,
wherein the display information change section replaces, when the guidance display information and the function display information change rule contain the symbol information which is not defined in the input information conversion table, the symbol information which is not defined in the input information conversion table, with the symbol information corresponding to unused input information, so as to change the guidance display information and the function display information change rule, and stores, in the display information storage section, the guidance display information and the function display information change rule having been changed.

4. A server device connected to a terminal device through a network, the server device and the terminal device being included in an operation guidance display system for outputting an operation guidance associated with an input device, the server device comprising:
a function display information management section for managing, in a function display information change rule, symbol information and a predetermined process which is to be executed when the symbol information is inputted, so as to uniquely associate the symbol information with the predetermined process;
a guidance display information management section for managing, as guidance display information, information used for generating operation auxiliary information corresponding to a display state of a GUI;
a display information change rule extraction section for performing, when receiving an input information conversion table in which input information inputted through the input device is uniquely associated with the symbol information, comparison among the symbol information contained in the input information conversion table, the symbol information contained in the function display information change rule, and the symbol information contained in the guidance display information, and extracting the function display information change rule and the guidance display information which are associated with the symbol information that is not contained in the input information conversion table;
a display information change section for changing the guidance display information and the function display information change rule, both of which are extracted by the display information change rule extraction section, so as to be associated with the symbol information contained in the input information conversion table; and
a transmission and reception section for receiving the input information conversion table from the terminal device through the network, and transmitting the function display information change rule and the guidance display information which have been changed by the display information change section, to the terminal device, through the network.

5. A terminal device connected to a server device through a network, the terminal device and the server device being included in an operation guidance display system for outputting an operation guidance associated with an input device, the terminal device comprising:
an input device information management section for managing, in an input information conversion table, input information inputted through the input device and symbol information, so as to uniquely associate the input information with the symbol information;
a display information storage section for storing a function display information change rule for managing the symbol information so as to be associated with a predetermined process which is to be executed when the symbol information is inputted, and guidance display information managed as information used for generating operation auxiliary information which is displayed so as to correspond to a display state of a GUI;
a transmission and reception section for transmitting, when the input information conversion table is updated, the input information conversion table having been updated, through the network to the server device, and receiving the guidance display information and the function display information change rule both of which are used for the input information conversion table having been updated, from the server device, through the network;
a function display section for converting the input information to the symbol information by using the input information conversion table managed by the input device information management section, and generating a GUI by executing the predetermined process in accordance with the function display information change rule corresponding to the symbol information obtained through conversion, and outputting the GUI having been generated; and
an operation guidance display section for generating the operation auxiliary information in accordance with the guidance display information, and outputting the operation auxiliary information having been generated.

6. A method performed by an operation guidance display apparatus for outputting an operation guidance associated with an input device,
wherein the operation guidance display apparatus includes:
an input device information management section for managing, in an input information conversion table, input information inputted through the input device and symbol information, so as to uniquely associate the input information with the symbol information;
a function display information management section for managing, in a function display information change rule, the symbol information and a predetermined process which is to be executed when the symbol information is inputted, so as to associate the symbol information with the predetermined process; and
a guidance display information management section for managing, as guidance display information, information used for generating operation auxiliary information corresponding to a display state of a GUI, said method comprising the steps of:
converting the input information to the symbol information by using the input information conversion table, and generating the GUI by executing the predetermined process in accordance with the function display information change rule corresponding to the symbol information obtained through conversion, and outputting the GUI having been generated;
generating the operation auxiliary information in accordance with the guidance display information, and outputting the operation auxiliary information having been generated;
performing comparison among the symbol information contained in the input information conversion table, the symbol information contained in the function display information change rule, and the symbol information contained in the guidance display information, and extracting the function display information change rule and the guidance display information which are associated with the symbol information that is not contained in the input information conversion table; and
a display information change step of changing the guidance display information and the function display information change rule having been extracted, so as to be associated with the symbol information contained in the input information conversion table.

7. An integrated circuit of an operation guidance display apparatus for outputting an operation guidance associated with an input device,
wherein the operation guidance display apparatus includes:
an input device information management section for managing, in an input information conversion table, input information inputted through the input device and symbol information, so as to uniquely associate the input information with the symbol information;
a function display information management section for managing, in a function display information change rule, the symbol information with a predetermined process which is to be executed when the symbol information is inputted, so as to associate the symbol information with the predetermined process; and
a guidance display information management section for managing, as guidance display information, information used for generating operation auxiliary information corresponding to a display state of a GUI, and
wherein said integrated circuit comprises:
a function display section for converting the input information to the symbol information by using the input information conversion table managed by the input device information management section, and generating the GUI by executing the predetermined process in accordance with the function display information change rule corresponding to the symbol information obtained through conversion, and outputting the GUI having been generated;
an operation guidance display section for generating the operation auxiliary information in accordance with the guidance display information managed by the guidance display information management section, and outputting the operation auxiliary information having been generated;
a display information change rule extraction section for performing comparison among the symbol information contained in the input information conversion table, the symbol information contained in the function display information change rule, and the symbol information contained in the guidance display information, and extracting the function display information change rule and the guidance display information which are associated with the symbol information that is not contained in the input information conversion table; and
a display information change section for changing the guidance display information and the function display information change rule, both of which are extracted by the display information change rule extraction section, so as to be associated with the symbol information contained in the input information conversion table.
